(19) United States
(12) Patent Application Publication
(10) Pub. No.: US 2021/0080568 A1
(43) Pub. Date: Mar. 18, 2021

(54) Underbody Radar Units

(71) Applicant: Waymo LLC, Mountain View, CA (US)

(72) Inventors: Adam Brown, Mountain View, CA (US); Larry Smith, Mountain View, CA (US)

(21) Appl. No.: 17/040,903

(22) PCT Filed: Apr. 25, 2018
(86) PCT No.: PCT/US2018/029388

§ 371 Date: Sep. 23, 2020

(51) Int. Cl. G01S 13/931; G01S 13/87

(52) U.S. Cl. CPC G01S 13/931; G01S 13/9004; G01S 13/87

(57) ABSTRACT

Example embodiments relate to underbody radar units. An example radar system may involve a set of radar units coupled to an underbody of a vehicle such that each radar unit has a field of view below a bumper line of the vehicle. The set of radar units may include a first radar unit configured to measure an environment of the vehicle in a first direction and a second radar unit configured to measure the environment of the vehicle in a second direction. The second direction differs from the first direction. In some implementations, the first radar unit is positioned proximate a front bumper of the vehicle, and the second radar unit is positioned proximate a back bumper of the vehicle. Other example configurations may involve using more or fewer radar units coupled to the underbody of a vehicle.

### BACKGROUND

Radio detection and ranging (radar) systems can be used to actively estimate distances to environmental features by emitting radio signals and detecting returning reflected signals. Distances to radio-reflective features can be determined according to the time delay between transmission and reception. A radar system can emit a signal that varies in frequency over time, such as a signal with a time-varying frequency ramp, and then relate the difference in frequency between the emitted signal and the reflected signal to a range estimate. Some radar systems may also estimate relative motion of reflective objects based on Doppler frequency shifts in the received reflected signals.

Directional antennas can be used for the transmission and/or reception of signals to associate each range estimate with a bearing. More generally, directional antennas can also be used to focus radiated energy on a given field of view of interest. Combining the measured distances and the directional information allows for the surrounding environment features to be mapped.

### SUMMARY

A vehicle radar system typically measures the environment surrounding a vehicle using radar units which are conventionally attached at locations of the vehicle, such as the side mirrors, roof, or doors of the vehicle. In contrast to the conventional, established approach, example embodiments presented herein describe vehicle radar systems that use radar units coupled to the underbody of the vehicle. Indeed, it has been recognized by applicant that by coupling a radar unit to the vehicle's underbody, the radar unit can have a new field of view (FOV) that encounters less interference (e.g. from other vehicles during operation of a fully autonomous or semi-autonomous vehicle) than do conventionally positioned radar units.

Accordingly, a first example embodiment may involve a radar system comprising a set of radar units coupled to an underbody of a vehicle such that each radar unit has a field of view below a bumper line of the vehicle. In the first example embodiment, the set of radar units includes: a first radar unit configured to measure an environment of the vehicle in a first direction and a second radar unit configured to measure the environment of the vehicle in a second direction. The second direction differs from the first direction.

A second example embodiment may involve operating a radar system. Particularly, the second embodiment may involve transmitting, by a first radar unit of a vehicle, radar signals in a first direction of an environment of the vehicle and receiving, at the first radar unit, reflected radar signals from the first direction of the environment. The second embodiment may also involve transmitting, by a second radar unit of the vehicle, radar signals in a second direction of the environment of the vehicle, and receiving, at the second radar unit, reflected radar signals from the second direction environment. In the second embodiment, the second direction differs from the first direction and the first radar unit and the second radar unit are coupled to an underbody of the vehicle such that each radar unit has a field of view below a bumper line of the vehicle.

A third example embodiment may involve radar system that includes a processor configured to process radar measurements and a set of radar units configurable to couple to an underbody of a vehicle such that each radar unit has a field of view below a bumper line of the vehicle. In the third embodiment, the set of radar units includes a first radar unit configured to measure an environment of the vehicle in a first direction and a second radar unit configured to measure the environment of the vehicle in a second direction. The second direction differs from the first direction.

A fourth embodiment may involve a system that includes various means for carrying out each of the operations of the first, second, and third embodiments.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 is a functional block diagram illustrating a vehicle, according to example embodiments.

FIG. 2 illustrates a physical configuration of a vehicle, according to example embodiments.

FIG. 3 illustrates a layout of radar sectors, according to example embodiments.

FIG. 4 illustrates beam steering for a sector for a radar unit, according to example embodiments.

FIG. 5A illustrates a side view of a vehicle with radar units coupled to the underbody of the vehicle in a first configuration, in accordance with example embodiments.

FIG. 5B illustrates a back view of the vehicle with radar units coupled to the underbody of the vehicle in the first configuration, in accordance with example embodiments.

FIG. 5C illustrates a bottom view of the vehicle with radar units coupled to the underbody of the vehicle in the first configuration, in accordance with example embodiments.

FIG. 5D illustrates an example path of operation for radar units coupled to the underbody of the vehicle, in accordance with example embodiments.

FIG. 6A illustrates a side view of a vehicle with radar units coupled to the underbody of the vehicle in a second configuration, in accordance with example embodiments.

FIG. 6B illustrates a back view of the vehicle with radar units coupled to the underbody of the vehicle in the second configuration, in accordance with example embodiments.

FIG. 6C illustrates a bottom view of the vehicle with radar units coupled to the underbody of the vehicle in the second configuration, in accordance with example embodiments.

FIG. 7A illustrates a side view of a vehicle configured with radar units coupled to the underbody of the vehicle below a bumper line of the vehicle, in accordance with example embodiments.

FIG. 7B illustrates a bottom view of the vehicle for positioning radar units to the vehicle, in accordance with example embodiments.

FIG. 8A illustrates a scenario involving a vehicle radar system detecting a nearby vehicle, according to example embodiments.

FIG. 8B illustrates another scenario involving a vehicle radar system detecting a nearby vehicle, according to example embodiments.

FIG. 9 is a flowchart of a method, in accordance with example embodiments.

FIG. 10A illustrates a side view of another vehicle with radar units coupled to the underbody of the vehicle, in accordance with example embodiments.

FIG. 10B illustrates a bottom view of the vehicle with radar units coupled to the underbody of the vehicle, in accordance with example embodiments.

FIG. 11 illustrates a schematic diagram of a computer program, in accordance with example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A radar system can use transmission antennas to emit (i.e. transmit) radar signals in predetermined directions to measure aspects of an environment. Upon coming into contact with surfaces in the environment, emitted radar signals can scatter in multiple directions with a portion of the emitted radar signal penetrating into surfaces and another portion of the radar signal reflecting off the surfaces back towards reception antennas that can capture the reflections. The received reflected signals are then processed to determine two dimensional (2D) or three dimensional (3D) measurements of the environment, including positions, orientations, and movements of various nearby surfaces.

Because a radar system can measure distances and motions of objects and other surfaces in the environment, radar systems are increasingly used in vehicle navigation and safety systems. A vehicle radar system can detect and help identify nearby vehicles, road boundaries, weather conditions (e.g., wet or snowy roadways), traffic signs and signals, and pedestrians, among other features in the surrounding environment. As such, radar measurements can be used when formulating control strategies for autonomous or semi-autonomous navigation.

It is now conventional practice for many vehicle radar systems to use radar units attached to side mirrors, bumpers, the roof, front grill, doors, or side panels on the vehicle. One reason for which the radar units are attached at these exterior locations is that it can enable the vehicle radar system to be installed on a standard vehicle without requiring redesigning and specially manufacturing the vehicle. In some instances, radar units are also positioned at these locations since these locations enable the orientation and positioning to the radar unit to be easily adjusted.

Various example embodiments presented herein depart from this conventional practice and involve coupling one or more radar units to the underbody of the vehicle. Indeed, it has been recognized that by positioning a radar unit on a vehicle's underbody, and thereby departing from conventional, established practice, a number of technical benefits may be provided. For instance, the radar unit positioned on a vehicle's underbody may have a position and field of view (FOV) that enables operations that radar units located at other exterior positions may fail to perform. In addition, a radar unit coupled to a vehicle's underbody can have a FOV that encounters less interference during operation, e.g., of a fully automated or semi-automated vehicle, compared with conventionally positioned radar units.

In contrast to conventionally positioned radar units, when a radar unit is coupled to the underbody, the radar unit is closer to the ground, which can result in a transmission and reception path with fewer obstacles, such as vehicle traveling nearby. Underbody radar may transmit and receive radar signals under neighboring vehicles and other obstacles. In such a configuration, wheels of the neighboring vehicles may correspond to the only portions of the neighboring vehicles likely to interfere with underbody radar units. As such, by positioning one or more radar units on the vehicle's underbody, the radar units may avoid interference from the vehicle bodies of nearby vehicles (which may be experienced by conventionally-positioned radar units) and may enable the radar unit to better measure the areas beyond the nearby vehicles. Also, by positioning one or more radar units on the vehicle's underbody, the radar units may avoid interference from certain portions of the body of the vehicle itself that might be experienced by conventionally-positioned radar units. As such, it may enable to the radar unit to more accurately measure areas close to, around, or under the vehicle, e.g. when compared to conventional roof or mirror mounted radar units which may fail to accurately measure areas around the vehicle. For instance, some roof-mounted radar units may have blind spots near the sides of the vehicle as the roofline can block the radar transmissions.

In addition, in some instances, underbody radar may utilize the proximity of the ground to scatter radar off the ground towards the environment in order to measure the surrounding environment. As such, the altered FOV of an underbody radar unit can result in detailed measurements of areas under and surrounding the vehicle. In turn, underbody radar may produce more accurate measurements of conditions of the path of travel, which can be used to detect road markers, potential hazards (e.g., potholes, bumps), and weather conditions (e.g., wet or snowy roads).

The configuration and layout of underbody radar units can be designed such that the vehicle minimally impacts its performance. In some examples, a radar unit may be coupled to the underbody (or bumper) of a vehicle at a position such that the radar unit has a FOV below the bumper line of the vehicle. As a result, the FOV may have transmission and reception path lower than the lowest part of the bumper (or vehicle portion) in the path (i.e., the bumper line of the vehicle). To further illustrate, a radar unit coupled to the underbody and configured to measure a forward path of the vehicle may have a position that results in a FOV that is below the portion of the front bumper positioned closest to the ground (i.e., the bumper line of the front bumper). Alternatively, a radar unit configured to measure the environment in multiple directions (e.g., 360 degrees around the vehicle) may have a position on the underbody that results in a FOV that is below the lowest portion of the lowest bumper of the vehicle. In other examples, the bumper line can correspond to other portions of the vehicle (e.g., elements of the vehicle frame) positioned proximate the ground under the vehicle.

In some examples, a radar unit may be coupled to the underbody of a vehicle at a position that is not below a bumper line of the vehicle (i.e., a horizontal transmission by the radar unit might be blocked by a portion of the vehicle). To enable the radar unit to capture measurements without interference from the vehicle, the radar unit may be coupled (or operate) at an orientation that allows the radar unit to avoid the portion of the vehicle in the direct path. For instance, a radar unit can be coupled at a downward orientation (e.g., 4 degrees downward from a horizontal plane) that enables measurements beyond the bumper or other portions of the vehicle that may have blocked the operation path of the radar unit if not for the downward orientation. Further, some underbody radar units may be configured to measure areas directly under the vehicle and do not require positions below a bumper line of the vehicle.

In addition, in further examples, one or more mechanical components may modify the position or orientation of an underbody radar unit to enable capturing measurements of targeted areas. For instance, a mechanical component (of either the radar system or the vehicle) may adjust the FOV, orientation, and/or height off the ground of a radar unit coupled to the underbody of the vehicle. Further, although the vehicle wheels may block some of the transmission or reception paths in some examples, radar units can be coupled at particular locations on the underbody to enable the radar system to obtain 360 degree measurements around the vehicle despite potential interference from the wheels. For example, the vehicle may have four underbody radars coupled near the four corners of the vehicle.

Within examples, different types of radar units can be coupled to the vehicle underbody to capture measurements for a vehicle radar system, including one or more radar units that operate at various ranges (e.g., short range, medium range) and azimuth angles (e.g., narrow beam, wide beam). For instance, short range radar units may be coupled to the underbody to perform operations that radar units coupled to side or top portions of the vehicle may fail to desirably perform. In particular, the short range radar units can measure road conditions (e.g., potholes, bumps, type of materials making up the underlying path, and slope of the path of travel), surface conditions (e.g., wet, snow, icy, oily, slushy, gravely conditions) of the path of travel, and/or objects, such as pedestrians, near the vehicle. In some instances, short range radar units may be used to determine the height or depth of obstacles or road conditions in the path of travel (e.g., depth of a pothole, height of a speed bump or non-level terrain). Underbody radar can also detect and measure road curbs, guardrails, and lane markers, among other ground aspects that can impact operation of the vehicle. The various radar measurements from one or more underbody radar units can assist safe navigation of the vehicle based on road and weather conditions.

In some examples, the underbody radar units may have a broadside beam directed at or slightly below the horizontal plane (as previously discussed). To make measurements of the road surface directly below the vehicle, the radar unit may take advantage of the grating lobes of the radar transmission. In practice, grating lobes can be conventionally undesirable. However, here, the grating lobes (i.e. the side lobes) can be used to make measurements of the road surface to aid the vehicle in determining a velocity of the vehicle, road surface conditions, etc. Put another way, one or more of the radar units may be oriented such that a main lobe of the radar unit is directed at or slightly below the horizontal plane and such that one or more side lobes is directed generally towards the road surface.

One or more underbody radar units may also be used to determine information related to operation of the vehicle and nearby vehicles (or other moving objects). For instance measurements from one or more radar units coupled to the underbody of the vehicle can be used to determine the pose of the vehicle (e.g., position and orientation within the environment). The vehicle control system may use the vehicle pose when determining control strategy within an environment. Further, in some examples, radar from one or more units coupled to the underbody of the vehicle can be used to determine the speed and/or orientation of vehicles traveling nearby. For example, the Doppler shift, azimuth angle, and range within radar measurements from underbody radar units can be used to estimate the wheel speed and orientation of a neighboring vehicle. In turn, the vehicle control system may use the measurements of the vehicle pose and/or measurements of nearby vehicles when determining navigation strategy.

Underbody radar may also be used to detect passengers entering or exiting the vehicle. In turn, the vehicle control system may keep the vehicle stationary until a passenger detected within a threshold distance from the vehicle either enters inside the vehicle or moves to a location that is a safe distance away from the vehicle. In additional examples, underbody radar can be used to enhance the overall experience of passengers, such as opening and closing a vehicle door based on the measured movements of a passenger. Similarly, radar measurements of the ground located under and around the vehicle can be used to ensure that the vehicle drops off a passenger in area that is safe for the passenger to exit the vehicle (e.g., a dry location free from mud, water, or snow).

In additional examples, underbody radar units may be coated to help reduce the impact of dirt, dust, water, ice, snow, and other materials that may impact performance. For example, a hydrophobic coating may be applied to an underbody radar unit to help repeal water or other substances that may come into contact with the radar unit during navigation of the vehicle. Further, positioning radar units to the underbody can reduce the likelihood of damage to the radar units by passengers or pedestrians.

Although examples are described involving underbody radar, other sensors may be coupled to the underbody to perform similar operations. For instance, alternative embodiments may involve using cameras or other types of sensors coupled to a vehicle underbody.

Further, example configurations describing arrangements of radar units on a vehicle's underbody are included herein for illustration purposes. Other configurations with different arrangements can be used, which may involve using more or fewer radar units overall. For instance, some embodiments may involve a single radar unit coupled to the underbody of the vehicle while others can involve coupling a few or even dozens of radar units to the underbody.

In addition, some embodiments may involve using different types of radar units (e.g., short range, medium, and long range) or combining radar units with other sensors. Additionally, some examples can involve using underbody radar units as part of a vehicle radar system that includes radar units positioned at other locations of the vehicle (e.g., on the roof, side mirrors). For example, in some examples, a radar system may be mounted to a roof of a vehicle to observe long distances away from the vehicle and underbody radar may be used to observe short and medium ranges away from the vehicle.

The following detailed description may be used with an apparatus (e.g., radar unit) having one or multiple antenna arrays that may take the form of a single-input single-output single-input, multiple-output (SIMO), multiple-input single-output (MISO), multiple-input multiple-output (MIMO), and/or synthetic aperture radar (SAR) radar antenna architecture.

In some embodiments, radar unit architecture may include a plurality of “dual open-ended waveguide” (DOEWG) antennas. The term “DOEWG” may refer to a short section of a horizontal waveguide channel plus a vertical channel that splits into two parts, where each of the two parts of the vertical channel may include an output port configured to radiate at least a portion of electromagnetic waves that enter the antenna. Additionally, in some instances, multiple DOEWG antennas may be arranged into an antenna array.

Some example radar systems may be configured to operate at an electromagnetic wave frequency in the W-Band, for example the frequency may be 77 Gigahertz (GHz), which corresponds to electromagnetic waves on the order of millimeters (e.g., 1 mm, 4 mm). The radar systems may use antennas that can focus radiated energy into tight beams to measure an environment with high accuracy. Such antennas may be compact (typically with rectangular form factors), efficient (i.e., with little of the 77 GHz energy lost to heat in the antenna or reflected back into the transmitter electronics), low cost and easy to manufacture (i.e., radar systems with these antennas can be made in high volume).

Some example radar architecture may include multiple metal layers (e.g., aluminum plates) machined with computer numerical control (CNC), aligned and joined together. For example, a metal layer may include a first half of an input waveguide channel, where the first half of the first waveguide channel includes an input port that may be configured to receive electromagnetic waves (e.g., W-band waves) into the first waveguide channel. The metal layer may also include a first half of a plurality of wave-dividing channels. The plurality of wave-dividing channels may comprise a network of channels that branch out from the input waveguide channel and that may be configured to receive the electromagnetic waves from the input waveguide channel, divide the electromagnetic waves into a plurality of portions of electromagnetic waves (i.e., power dividers), and propagate respective portions of electromagnetic waves to respective wave-radiating channels of a plurality of wave-radiating channels. The waveguide antenna elements and/or the waveguide output ports may be rectangular in shape, in some embodiments. In alternative embodiments, the waveguide antenna elements and/or the waveguide output ports may be circular in shape. Other shapes are also possible.

Based on the shape and the materials of the corresponding polarization-modification channels and waveguides, the distribution of propagating energy can vary at different locations within the antenna, for example. The shape and the materials of the polarization-modification channels and waveguides define the boundary conditions for the electromagnetic energy. Boundary conditions are known conditions for the electromagnetic energy at the edges of the polarization-modification channels and waveguides. For example, in a metallic waveguide, assuming the polarization-modification channel and waveguide walls are nearly perfectly conducting (i.e., the waveguide walls can be approximated as perfect electric conductors—PECs), the boundary conditions specify that there is no tangentially (i.e., in the plane of the waveguide wall) directed electric field at any of the wall sides. Once the boundary conditions are known, Maxwell's Equations can be used to determine how electromagnetic energy propagates through the polarization-modification channels and waveguides.

Maxwell's Equations may define several modes of operation for any given polarization-modification channel or waveguide. Each mode has one specific way in which electromagnetic energy can propagate through the polarization-modification channel or waveguide. Each mode has an associated cutoff frequency. A mode is not supported in a polarization-modification channel or waveguide if the electromagnetic energy has a frequency that is below the cutoff frequency. By properly selecting both (i) dimensions and (ii) frequency of operation, electromagnetic energy may propagate through the polarization-modification channels and waveguides in specific modes. The polarization-modification channels and/or the waveguides can be designed so only one propagation mode is supported at the design frequency.

There are four main types of waveguide propagation modes: Transverse Electric (TE) modes, Transverse Magnetic (TM) modes, Transverse Electromagnetic (TEM) modes, and Hybrid modes. In TE modes, the electromagnetic energy has no electric field in the direction of the electromagnetic energy propagation. In TM modes, the electromagnetic energy has no magnetic field in the direction of the electromagnetic energy propagation. In TEM modes, the electromagnetic energy has no electric or magnetic field in the direction of the electromagnetic energy propagation. In Hybrid modes, the electromagnetic energy has some of both electric field and magnetic field the direction of the electromagnetic energy propagation.

TE, TM, and TEM modes can be further specified using two suffix numbers that correspond to two directions orthogonal to the direction of propagation, such as a width direction and a height direction. A non-zero suffix number indicates the respective number of half-wavelengths of the electromagnetic energy equal to the width and height of the respective polarization-modification channel or waveguide (e.g., assuming a rectangular waveguide). However, a suffix number of zero indicates that there is no variation of the field with respect to that direction. For example, a TE₁₀ mode indicates the polarization-modification channel or waveguide is half-wavelength in width and there is no field variation in the height direction. Typically, when the suffix number is equal to zero, the dimension of the waveguide in the respective direction is less than one-half of a wavelength. In another example, a TE₂₁ mode indicates the waveguide is one wavelength in width (i.e., two half wavelengths) and one half wavelength in height.

When operating a waveguide in a TE mode, the suffix numbers also indicate the number of field-maximums along the respective direction of the waveguide. For example, a TE₁₀ mode indicates that the waveguide has one electric field maximum in the width direction and zero maxima in the height direction. In another example, a TE₂₁ mode indicates that the waveguide has two electric field maxima in the width direction and one maximum in the height direction.

Additionally or alternatively, different radar units using different polarizations may prevent interference between different radars in the radar system. For example, the radar system may be configured to interrogate (i.e., transmit and/or receive radar signals) in a direction normal to the direction of travel of an autonomous vehicle via SAR functionality. Thus, the radar system may be able to determine information about roadside objects that the vehicle passes. In some examples, this information may be two dimensional (e.g., distances various objects are from the roadside). In other examples, this information may be three dimensional (e.g., a point cloud of various portions of detected objects). Thus, the vehicle may be able to “map” the side of the road as it drives along, for example.

Some examples may involve using radar units having antenna arrays arranged in MIMO architecture. Particularly, the filter may be determined to adjust near-field measurements may by a radar unit having antenna arrays arranged in MIMO architecture. Radar signals emitted by the transmission antennas are orthogonal to each other and can be received by one or multiple corresponding reception antennas. As such, the radar system or associated signal processor can perform 2D SAR image formation along with a 3D matched filter to estimate heights for pixels in a 2D SAR map formed based on the processed radar signals.

If two autonomous vehicles are using analogous radar systems to interrogate the environment (e.g., using the SAR technique described above), it could also be useful for those autonomous vehicles to use different polarizations (e.g., orthogonal polarizations) to do the interrogation, thereby preventing interference. Additionally, a single vehicle may operate two radars units having orthogonal polarizations so that each radar unit does not interfere with the other radar unit.

Further, the configuration of a radar system can differ within examples. For instance, some radar systems may consist of radar units that are each configured with one or more antennas arrays. An antenna array may involve a set of multiple connected antennas that can work together as a single antenna to transmit or receive signals. By combining multiple radiating elements (i.e., antennas), an antenna array may enhance the performance of the radar unit when compared to radar units that use non-array antennas. In particular, a higher gain and narrower beam may be achieved when a radar unit is equipped with one or more antenna arrays. As a result, a radar unit may be designed with antenna arrays in a configuration that enables the radar unit to measure particular regions of the environment, such as targeted areas positioned at different ranges (distances) from the radar unit.

Radar units configured with antenna arrays can differ in overall configuration. For instance, the number of arrays, position of arrays, orientation of arrays, and size of antenna arrays on a radar unit can vary in examples. In addition, the quantity, position, alignment, and orientation of radiating elements (antennas) within an array of a radar unit can also vary. As a result, the configuration of a radar unit may often depend on the desired performance for the radar unit. For example, the configuration of a radar unit designed to measure distances far from the radar unit (e.g., a far range of the radar unit) may differ compared to the configuration of a radar unit used to measure an area nearby the radar unit (e.g., a near field of the radar unit).

To further illustrate, in some examples, a radar unit may include the same number of transmission antenna arrays and reception antenna arrays (e.g., four arrays of transmission antennas and four arrays of reception antennas). In other examples, a radar unit may include a number of transmission antenna arrays that differs from the number of reception antenna arrays (e.g., 6 transmission antenna arrays and 3 reception antenna arrays). In addition, some radar units may operate with parasitic arrays that can control radar transmissions. Other example radar units may include one or multiple driven arrays that have radiating elements connected to an energy source, which can have less overall energy loss when compared to parasitic arrays.

Antennas on a radar unit may be arranged in one or more linear antenna arrays (i.e., antennas within an array are aligned in a straight line). For instance, a radar unit may include multiple linear antenna arrays arranged in a particular configuration (e.g., in parallel lines on the radar unit). In other examples, antennas can also be arranged in planar arrays (i.e., antennas arranged in multiple, parallel lines on a single plane). Further, some radar units can have antennas arranged in multiple planes resulting in a three dimensional array.

A radar unit may also include multiple types of arrays (e.g., a linear array on one portion and a planar array on another portion). As such, radar units configured with one or more antenna arrays can reduce the overall number of radar units a radar system may require to measure a surrounding environment. For example, a vehicle radar system may include radar units with antenna arrays that can be used to measure particular regions in an environment as desired while the vehicle navigates.

Some radar units may have different functionality and operational characteristics. For example, a radar unit may be configured for long-range operation and another radar unit may be configured for short-range operation. A radar system may use a combination of different radar units to measure different areas of the environment. Accordingly, it may be desirable for the signal processing of short-range radar units to be optimized for radar reflections in the near-field of the radar unit.

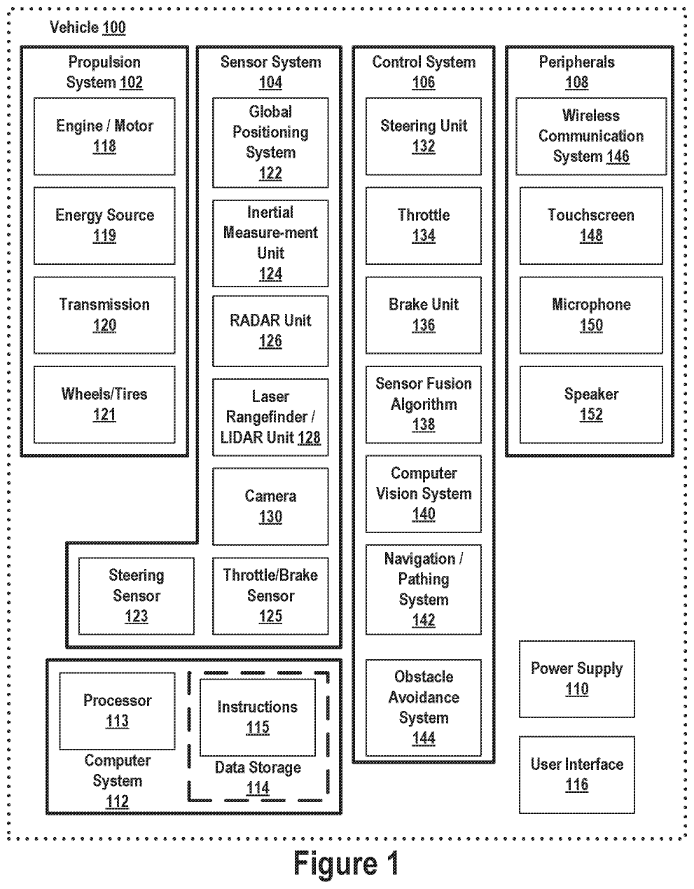

Referring now to the figures, FIG. 1 is a functional block diagram illustrating example vehicle 100, which may be configured to operate fully or partially in an autonomous mode. More specifically, vehicle 100 may operate in an autonomous mode without human interaction (or reduced human interaction) through receiving control instructions from a computing system (e.g., a vehicle control system). As part of operating in the autonomous mode, vehicle 100 may use sensors to detect and possibly identify objects of the surrounding environment in order to enable safe navigation. In some implementations, vehicle 100 may also include subsystems that enable a driver (or a remote operator) to control operations of vehicle 100.

As shown in FIG. 1, vehicle 100 includes various subsystems, such as propulsion system 102, sensor system 104, control system 106, one or more peripherals 108, power supply 110, computer system 112, data storage 114, and user interface 116. In other examples, vehicle 100 may include more or fewer subsystems. The subsystems and components of vehicle 100 may be interconnected in various ways (e.g., wired or wireless connections). In addition, functions of vehicle 100 described herein can be divided into additional functional or physical components, or combined into fewer functional or physical components within implementations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, an electric motor, steam engine, or Stirling engine, among other possible options. For instance, in some implementations, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118). For instance, energy source 119 can correspond to gasoline, diesel, other petroleum-based fuels, propane, other compressed gas-based fuels, ethanol, solar panels, batteries, and/or other sources of electrical power. In some implementations, energy source 119 may include a combination of fuel tanks, batteries, capacitors, and/or flywheels.

Transmission 120 may transmit mechanical power from engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example implementations. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, radar unit 126, laser rangefinder/LIDAR unit 128, camera 130, steering sensor 123, and throttle/brake sensor 125, among other possible sensors. In some implementations, sensor system 104 may also include sensors configured to monitor internal systems of the vehicle 100 (e.g., O₂ monitors, fuel gauge, engine oil temperature, condition of brakes).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar unit 126 may represent one or more systems configured to use radio signals to sense objects, including the speed and heading of the objects, within the local environment of vehicle 100. As such, radar unit 126 may include antennas configured to transmit and receive radar signals as discussed above. In some implementations, radar unit 126 may correspond to a mountable radar system configured to obtain measurements of the surrounding environment of vehicle 100. For example, radar unit 126 can include one or more radar units configured to couple to the underbody of a vehicle.

Laser rangefinder/LIDAR 128 may include one or more laser sources, a laser scanner, and one or more detectors, among other system components, and may operate in a coherent mode (e.g., using heterodyne detection) or in an incoherent detection mode. Camera 130 may include one or more devices (e.g., still camera or video camera) configured to capture images of the environment of vehicle 100.

Steering sensor 123 may sense a steering angle of vehicle 100, which may involve measuring an angle of the steering wheel or measuring an electrical signal representative of the angle of the steering wheel. In some implementations, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, an angle of a gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve or carburetor). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, throttle/brake sensor 125 may be configured to measure a pressure applied to a pedal of the vehicle, such as a throttle or brake pedal.

Control system 106 may include components configured to assist in navigating vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some implementations, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some implementations, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software operable to process and analyze images in an effort to determine objects, environmental objects (e.g., stop lights, road way boundaries, etc.), and obstacles. As such, computer vision system 140 may use object recognition, Structure From Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, microphone 150, and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may wirelessly communicate with one or more devices directly or via a communication network. For example, wireless communication system 146 could use 3G cellular communication, such as CDMA, EVDO, GSM/GPRS, or 4G cellular communication, such as WiMAX or LTE. Alternatively, wireless communication system 146 may communicate with a wireless local area network (WLAN) using WiFi or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some implementations. For instance, power supply 110 may include one or more batteries configured to provide electrical power. Vehicle 100 may also use other types of power supplies. In an example implementation, power supply 110 and energy source 119 may be integrated into a single energy source.

Vehicle 100 may also include computer system 112 to perform operations, such as operations described therein. As such, computer system 112 may include at least one processor 113 (which could include at least one microprocessor) operable to execute instructions 115 stored in a non-transitory computer readable medium, such as data storage 114. In some implementations, computer system 112 may represent a plurality of computing devices that may serve to control individual components or subsystems of vehicle 100 in a distributed fashion.

In some implementations, data storage 114 may contain instructions 115 (e.g., program logic) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, and control system 106), as well as from user interface 116. For example, computer system 112 may utilize input from sensor system 104 in order to estimate the output produced by propulsion system 102 and control system 106. Depending upon the embodiment, computer system 112 could be operable to monitor many aspects of vehicle 100 and its subsystems. In some embodiments, computer system 112 may disable some or all functions of the vehicle 100 based on signals received from sensor system 104.

The components of vehicle 100 could be configured to work in an interconnected fashion with other components within or outside their respective systems. For instance, in an example embodiment, camera 130 could capture a plurality of images that could represent information about a state of an environment of vehicle 100 operating in an autonomous mode. The state of the environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar unit 126 may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some embodiments, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors.

Although FIG. 1 shows various components of vehicle 100, i.e., wireless communication system 146, computer system 112, data storage 114, and user interface 116, as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

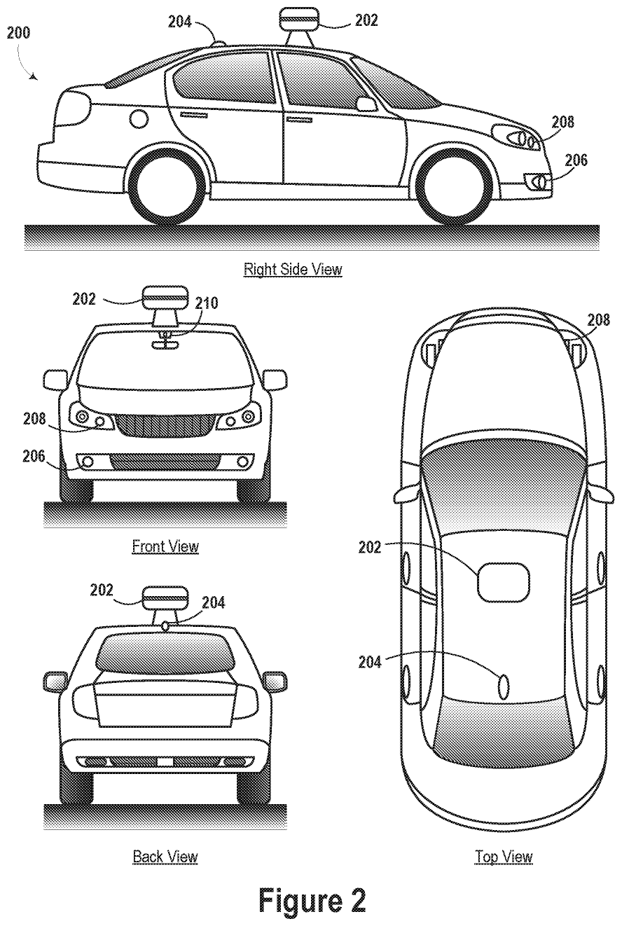

FIG. 2 illustrates a physical configuration of vehicle 200, which may represent one possible physical configuration of vehicle 100 described in reference to FIG. 1. Depending on the embodiment, vehicle 200 may include sensor unit 202, wireless communication system 204, radio unit 206, deflectors 208, and camera 210, among other possible components. For instance, vehicle 200 may include some or all of the elements of components described in FIG. 1. Although vehicle 200 is depicted in FIG. 2 as a car, vehicle 200 can have other configurations within examples, such as a truck, a van, a semi-trailer truck, a motorcycle, a bus, a shuttle, a golf cart, an off-road vehicle, robotic device, or a farm vehicle, among other possible examples.

Sensor unit 202 may include one or more sensors configured to capture information of the surrounding environment of vehicle 200. For example, sensor unit 202 may include any combination of cameras, radars, LIDARs, range finders, radio devices (e.g., Bluetooth and/or 802.11), and acoustic sensors, among other possible types of sensors. In some implementations, sensor unit 202 may include one or more movable mounts operable to adjust the orientation of sensors in sensor unit 202. For example, the movable mount may include a rotating platform that can scan sensors so as to obtain information from each direction around vehicle 200. The movable mount of sensor unit 202 may also be movable in a scanning fashion within a particular range of angles and/or azimuths.

In some implementations, sensor unit 202 may include mechanical structures that enable sensor unit 202 to be mounted atop the roof of a car. Additionally, other mounting locations are possible within examples.

Wireless communication system 204 may have a location relative to vehicle 200 as depicted in FIG. 2, but can also have different locations. Wireless communication system 200 may include one or more wireless transmitters and one or more receivers that may communicate with other external or internal devices. For example, wireless communication system 204 may include one or more transceivers for communicating with a user's device, other vehicles, and roadway elements (e.g., signs, traffic signals), among other possible entities. As such, vehicle 200 may include one or more vehicular communication systems for facilitating communications, such as dedicated short-range communications (DSRC), radio frequency identification (RFID), and other proposed communication standards directed towards intelligent transport systems.

Camera 210 may have various positions relative to vehicle 200, such as a location on a front windshield of vehicle 200. As such, camera 210 may capture images of the environment. For instance, camera 210 may capture images from a forward-looking view with respect to vehicle 200, but other mounting locations (including movable mounts) and viewing angles of camera 210 are possible within implementations. In some examples, camera 210 may correspond to one or more visible light cameras, but can also be other types of cameras (e.g., infrared sensor). Camera 210 may also include optics that may provide an adjustable field of view.

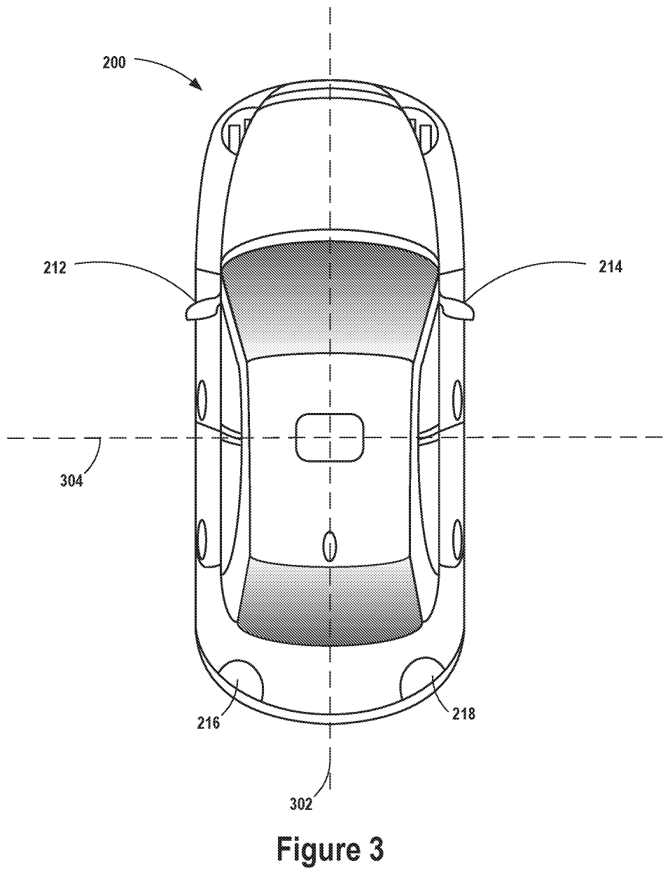

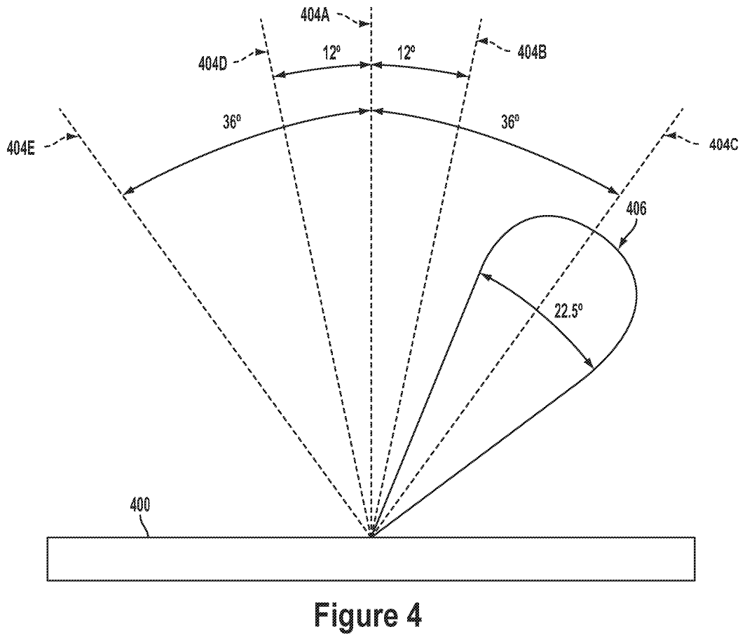

FIG. 3 illustrates an example layout of radar sectors for autonomous vehicle 200. As shown, each radar sector may have an angular width approximately equal to the scanning range of the radar units (as will be described with respect to FIG. 4). For example, the sectors may divide the azimuth plane around autonomous vehicle 200 into multiple sectors (e.g., 90 degree sectors, 120 degree sectors).

The example radar sectors may align with axes 302, 304 relative to vehicle 200. In some instances, each radar unit may be configured to scan across one sector. Further, because each example radar unit of FIG. 3 has a scanning angle of approximately 90 degrees, each radar unit scans a region that may not overlap with the scanning angle of other radar units. In other examples, the sectors may overlap.

In order to achieve radar sectors defined by the midpoints of vehicle 200, each radar unit may be mounted at a 45-degree angle with respect to the two axes of vehicle 200. By mounting each radar unit a 45 degree angle with respect to the two axes of vehicle 200, a 90 degree scan of the radar unit would scan from one vehicle axis to the other vehicle axis. For example, a radar unit mounted at a 45-degree angle to the axes in side mirror unit 212 may be able to scan the front left sector (i.e. from vertical axis 302 through the front of vehicle 200 to horizontal axis 304 that runs through the side of the vehicle).

An additional radar unit may be mounted at a 45-degree angle to the axes in side mirror unit 214 may be able to scan the front right sector. In order to scan the back right sector, a radar unit may be mounted in taillight unit 218. Additionally, in order to scan the back left sector, a radar unit may be mounted in taillight unit 216. The radar unit placements shown in FIG. 3 are merely to illustrate one possible example.

In various other examples, radar units may be placed in other locations, such as on top or along (or within) other portions of the vehicle, and/or coupled to the underbody of vehicle 200. Further, the sectors may also be defined differently in other embodiments. For example, the sectors may be at a 45-degree angle with respect to the vehicle. In this example, one radar unit may face forward, another backward, and the other two to the sides of the vehicle.

In some examples, all the radar units of vehicle 200 may be configured with the same scanning angle. The azimuth plane around the vehicle is equal to a full 360 degrees. Thus, if each radar unit is configured with the same scanning angle, then the scanning angle for the radar units would be equal to approximately 360 divided by the number of radar units on the vehicle. Thus, for full azimuth plane scanning, vehicle 200 with one radar unit would need that radar unit to be able to scan over the full 360 degrees.

If vehicle 200 had two radar units, each would scan approximately 180 degrees. For three radar units, each would be configured to scan 120 degrees. For four radar units, as shown in FIG. 3, each may scan approximated 90 degrees. Five radar units may be configured on vehicle 200 and each may be able to scan 72 degrees. Further, six radar units may be configured on vehicle 200 and each may be able to scan approximately 60 degrees.

### Other Examples are Possible

In further examples, the number of radar units may be chosen based on a number of criteria, such as ease of manufacture of the radar units, vehicle placement, or other criteria. For example, some radar units may be configured with a planar structure that is sufficiently small. The planar radar unit may be mountable at various positions on a vehicle. For example, a vehicle may have a dedicated radar housing mounted on the top of the vehicle. The radar housing may contain various radar units. In other embodiments, radar units may be placed within the vehicle structure.

In some embodiments, it may be desirable to place radar units in positions where the object covering the radar unit is at least partially transparent to radar. For example, various plastics, polymers, and other materials may form part of the vehicle structure and cover the radar units, while allowing the radar signal to pass through.

Additionally, in some embodiments, the radar units may be configured with different scanning ranges for different radar units. In some embodiments, a specific radar unit with a wide scanning angle may not be able to be placed on the vehicle in the proper location. Thus, a smaller radar unit, with a smaller scanning angle may be placed in that location. However, other radar units may be able to have larger scanning angles. Therefore, the total scanning angle of the radar units may add up to 360 degrees (or more) and provide full 360 degree azimuthal scanning. For example, a vehicle may have 3 radar units that each scan over 100 degrees and a fourth radar unit that scans over 60 degrees. Thus, the radar units may be able to scan the full azimuth plane, but the scanning sectors may not be equal in angular size.

FIG. 4 illustrates example beam steering for a sector for radar unit 400. Radar unit 400 may be configured with a steerable beam (i.e., radar unit 400 may be able to control a direction in which the beam is radiated). By controlling the propagation direction, radar unit 400 may direct radiation and measure a desired area of the environment. In some examples, radar unit 400 may scan a radar beam in a continuous manner across various angles of the azimuth plane. In other embodiments, radar unit 400 may scan the radar beam in discrete steps across angles of the azimuth plane.

As shown in FIG. 4, radar unit 400 can generate steerable radar beam 406, which may have a half-power beamwidth of approximately 22.5 degrees. For instance, the half-power beam width describes the width, measured in degrees, of a main lobe of radar beam 406 between two points that correspond to half the amplitude of the maximum of radar beam 406. Alternatively, the half-power beam width of radar beam 406 may be different than 22.5 degrees.

Additionally, in some embodiments, the half-power beam width of radar beam 406 may change depending on the angle at which radar beam 406 is pointed. For example, the half-power beam width of radar beam 406 may be narrower when radar beam 406 is pointed more closely to orthogonal 404A (i.e. broadside) direction to the radiating surface and widen and radar beam 406 is steered away from the orthogonal direction 404A.

As further shown in FIG. 4, radar unit 400 may be configured to steer radar beam 406 in different angles (e.g., four different angles). The steering angle may be measured with respect to orthogonal 404A (i.e. broadside) direction to the radiating surface. Radar beam 406 may also be steered to +36 degrees at 404C and −36 degrees at 404E, for example. Also, radar beam 406 may be steered to +12 degrees at 404B and −12 degrees at 404D. The four different angles may represent the discrete angles to which radar beam 406 may be steered.

In some additional examples, radar unit 400 may steer radar beam 406 to two angles simultaneously. For example, radar unit 400 may steer radar beam 406 to both +12 and −12 degrees at the same time. This may result in a beam that is overall steered in the direction of the sum of the angles (e.g. −12+12=0, thus the beam in this example would be in the broadside direction 404a). However, when a radar beam is steered at two directions at once, the half-power beam width of the radar beam may be widened. Thus, a radar resolution may decrease.

By steering radar beam 406 to each of angles 404B-404E, the full 90-degree field of view can be scanned. For example, when radar beam 406 is steered to +36 degrees 404C, the half-power beam width of radar beam 406 will cover from +47.25 degrees to +24.75 degrees (as measured from the broadside direction 404A). Additionally, when radar beam 406 is steered to −36 degrees 404E, the half-power beam width of radar beam 406 can cover from −47.25 degrees to −24.75 degrees. Further, when radar beam 406 is steered to +12 degrees 404B, the half-power beam width of radar beam 406 will cover from +23.25 degrees to +0.75 degrees. And finally, when radar beam 406 is steered to −12 degrees 404D, the half-power beam width of radar beam 406 will cover from −23.25 degrees to −0.75 degrees. Thus, radar beam 406 will effectively be able to scan (i.e. selectively enable or disable the four beams spanning the angular width) from −47.25 to +47.25 degrees, covering a range of 95 degrees. The number of steering angles, the direction of the steering angles, and the half-power beam width of radar beam 406 may be varied depending on the specific example.

For example, and further discussed below, a radar beam of a radar unit may be configured to only scan a 60-degree region. If a radar unit can scan a 60-degree region, six radar units may be used to scan a full 360 azimuth plane. However, if the radar unit can scan 90 degrees, four radar units may scan the full 360 azimuth plane.

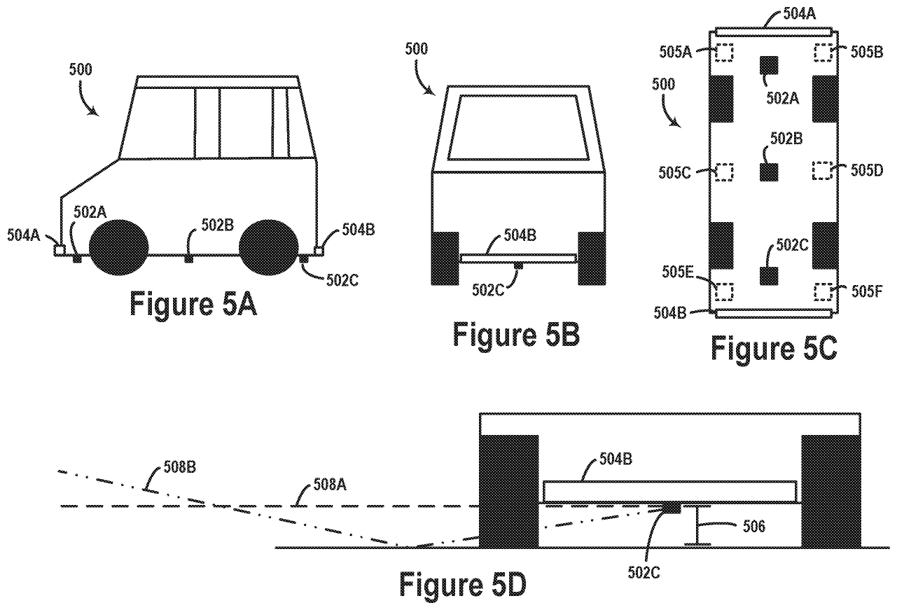

FIGS. 5A, 5B, 5C, and 5D illustrate a first example configuration for coupling radar units 502A, 502B, and 502C to the underbody of vehicle 500. Other example configurations for coupling underbody radar units can involve using more or fewer radar units in other arrangements. The type and performance of radar units 502A, 502B, and 502C can vary within examples as well. For instance, the range, update rate, FOV, and range resolution may differ depending on the radar units used in the example implementation.

In some examples, radar units 502A, 502B, and 502C may provide high resolution range and azimuth information to a vehicle control system or another computing system (e.g., a remotely positioned computing system) that can be used for navigation and mapping purposes (e.g., SAR mapping and localization). Radar measurements can also be used to detect passengers, pedestrians (e.g., cyclists), animals, or other motion (e.g., other vehicles) within a threshold range around the vehicle. For instance, underbody radar measurements can indicate when a passenger is approaching vehicle 500 or when a passenger exiting vehicle 500 is located far enough away that vehicle 500 can resume navigation.

Further, because the radar units (e.g., radar units 502A, 502B, and 502C) are shown attached to the underbody of the vehicle, components used to couple each radar unit to the underbody do not need to be aesthetically pleasing. When radar units are coupled at exterior vehicle positions (e.g., doors, side mirrors), there might be a desire to connect each radar unit in a visibly-appealing manner (e.g., make the attachment of a radar unit look minimal and professionally performed). Moving the locations of radar units to the underbody can reduce or eliminate this desire to couple radar units in a visibly appealing manner. This may allow the mechanism by which radar units are coupled to the vehicle to be simplified. In addition, radar positioned on the underbody could avoid reducing the aesthetic appeal of the vehicle.

FIG. 5A depicts a side view of vehicle 500 with radar units 502A, 502B, and 502C coupled to the underbody of vehicle 500. In particular, radar unit 502A is coupled to the underbody at a location in front of the front wheels (i.e., by front bumper 504A of vehicle 500), radar unit 502B is coupled to the underbody at a location in between the front wheels and back wheels of vehicle 500 and radar unit 502C is coupled to the underbody at a location behind the back wheels of vehicle 500 (i.e., proximate back bumper 504B of vehicle 500). These locations are shown for illustration purposes, but can differ in other implementations. Further, radar units 502A, 502B, 502C may be positioned and/or oriented (e.g., a 5 degree downward orientation) below one or more bumper lines (e.g., below bottom portions of front bumper 504A and back bumper 504B) of vehicle 500 such that each radar unit has a FOV that is not blocked by bumpers (e.g., 504A, 504B) or other elements of vehicle 500 except for the wheels of vehicle 500.

Radar unit 502A is shown positioned proximate front bumper 504A of vehicle 500 and may correspond to a forward-facing radar unit configured to measure a forward-looking environment of vehicle 500. In some instances, the forward-looking environment may be an area directly in front of vehicle 500. In other examples, the forward-looking environment may correspond to a wider area surrounding the front portion of vehicle 500 (e.g., the front and side areas of vehicle 500). In additional examples, radar unit 502A may measure other areas under or around vehicle 500 (e.g., measure directions 360 degrees around radar unit 502A).

Radar unit 502B is shown positioned in between the front wheels and the back wheels of vehicle 500. As such, radar unit 502B may have a FOV that enables radar unit 502B to measure areas nearby the doors of vehicle 500. In further examples, radar unit 502B may be configured to measure other areas relative to vehicle 500, such as an area below vehicle 500 and/or a 360 area around vehicle 500. Similar to radar unit 502A, radar unit 502B may be coupled at various heights off the ground and/or orientations relative to the underbody of vehicle 500 within examples.

Radar unit 502C is shown coupled to the underbody proximate back bumper 504B of vehicle 500 and may correspond to a rear-facing radar unit configured to measure a rear-looking environment of vehicle 500. As such, radar unit 502C may have a FOV that is below a bumper line of back bumper 504B of vehicle 500. In some examples, radar unit 502C may measure an area positioned directly behind vehicle 500. In other examples, radar unit 502C may be configured to measure a wider area surrounding the back portion (or other portions) of vehicle 500 (e.g., the back and side areas of vehicle 500). Similar to radar units 502A, 502B, radar unit 502C may be coupled at various heights off the ground and/or orientations relative to the underbody of vehicle 500 within examples.

FIG. 5B illustrates a back view of the vehicle with radar units coupled to the underbody of the vehicle in the first configuration. Particularly, radar unit 502C is shown below the bumper line (e.g., bottom portion of bumper 504B) and positioned approximate in a center of vehicle 500. As such, radar units 502A and 502B may also be aligned with the center of vehicle 500 similar to radar unit 502C. In other examples, one or more of radar units 502A, 502B, and 502C may be offset from the center of vehicle 500.

FIG. 5C illustrates a bottom view of vehicle 500 with radar units 502A, 502B, and 502C coupled to the underbody of the vehicle in the first configuration. As discussed above, although radar units 502A, 502B, and 502C are shown positioned along a centerline of vehicle 500, one or more radar units may be offset in other examples.

In addition, FIG. 5C further includes optional radar positions 505A, 505B, 505C, 505D, 505E, and 505F. In particular, optional radar positions 505A, 505B represent positions proximate front bumper 504A. Radar units placed at radar positions 505A, 505B may operate at the front corners of vehicle 500. Similarly, radar units placed at radar positions 505C, 505D may operate at side positions of vehicle. Further, optional radar positions 505E, 505F represent positions proximate back bumper 504B of vehicle 500. Radar units placed at radar positions 505E, 505F may operate at the back corners of vehicle 500. Other example optional radar positions on the underbody of vehicle 500 are possible.

FIG. 5D illustrates an example FOV radar unit 502C coupled to the underbody of vehicle 500. Particularly, underbody scattering associated with radar unit 502C (or another radar unit) may enable both direct path 508A and indirect path 508B detection of nearby objects, including road elements, nearby vehicles, pedestrians, or other features in the environment. Radar unit 502C is also shown positioned at height 506 (e.g., 6 inches) from the ground surface below vehicle 500. Height 506 can vary within examples and type of vehicle used.

As further shown in FIG. 5D, radar unit 502C may transmit and receive radar in multiple paths that extend below and away from vehicle 500 without interference from back bumper 504B. For instance, radar unit 502C may transmit and receive radar via direct path 508A that extends approximately parallel to the ground from radar unit 502C. In addition, radar unit 502C may also transmit and receive radar via indirect path 508B, which may involve transmitting radar at a downward orientation towards the ground such that the radar bounces off the ground towards surfaces in the environment. For example, at ranges greater than 2 meters from the underbody radar unit, indirect path 508B may enable detection of structures above the bottom body line of the vehicle, including an elevation channel (at the cost of some azimuth resolution) can yield reasonable height estimates for object at range, presuming the scene is reasonably sparse. As such, direct path 508A and indirect path 508B shown in FIG. 5D can be valid for all angles in the 360 degree FOV of radar unit 502C.

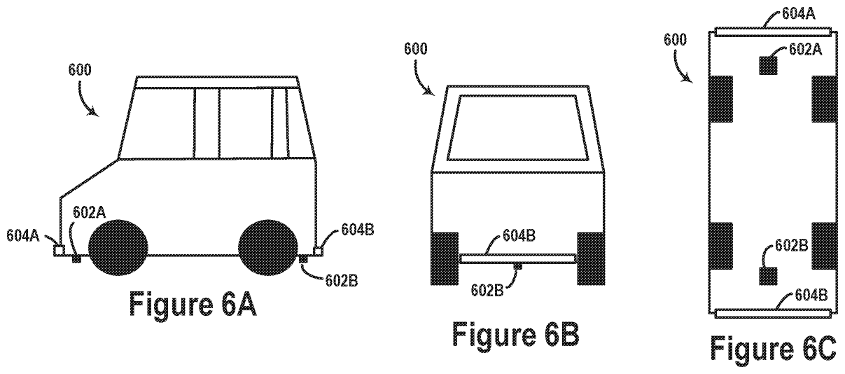

FIGS. 6A, 6B, and 6C illustrate another example layout for coupling radar units 602A and 602B to the underbody of vehicle 600. Particularly, unlike the first example configuration depicted in FIGS. 5A-5D, radar units 602A, 602B are shown coupled to the underbody of vehicle 600 in a second configuration that involves one fewer radar unit. Other example layouts for coupling radar units to the underbody of a vehicle are possible.

FIG. 6A illustrates a side view of vehicle 600 with radar units 602A, 602B coupled to the underbody of vehicle 600 in the second configuration. More specifically, radar unit 602A is shown coupled proximate to front bumper 604A of vehicle 600 such that radar unit 602A may have a FOV that enables measurements of areas positioned in front of vehicle 600 without interference from front bumper 604A. Similar to radar unit 502C, radar unit 602B is shown coupled proximate to back bumper 604B of vehicle 600 such that radar unit 602B may have a FOV that enables measurements of areas positioned behind vehicle 600 without interference from back bumper 604B.

FIG. 6B illustrates a back view of vehicle 600 with radar units 602A, 602B coupled to the underbody of vehicle 600 in the second configuration. Particularly, radar unit 602B is shown below a bumper line of vehicle 600 (e.g., back bumper 604B) and positioned approximate on a centerline of vehicle 600. As such, radar units 602A may also be aligned with the center line of vehicle 600 similar to radar unit 602B. In other examples, one or more of radar units may be offset from the center of vehicle 600.

FIG. 6C illustrates a back view of the vehicle with radar units coupled to the underbody of the vehicle in the second configuration. In some examples, radar unit 602A, 602B may capture measurements under and around vehicle 600 using four apertures each. In other examples, radar units 602A, 602B may capture measurements under or nearby vehicle 600 using other numbers of apertures. Vehicle 600 can have radar units positioned at other locations on its underbody in some examples.

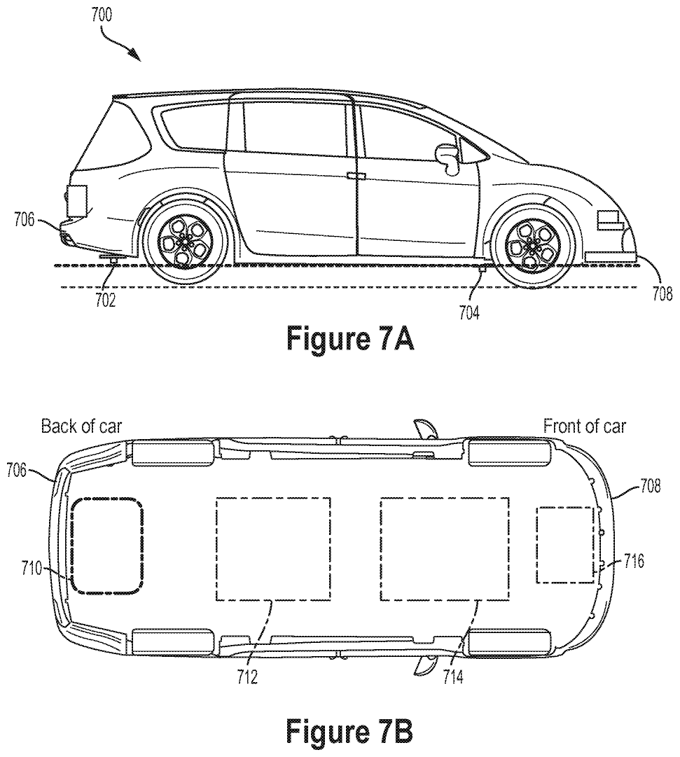

FIG. 7A illustrates a side view of a vehicle configured with radar units coupled to the underbody of the vehicle below a bumper line of the vehicle. As shown, vehicle 700 includes radar units 702 and 704 coupled to its underbody. Vehicle 700 serves as one example, but other vehicles may similar have radar units coupled to its underbody at one or multiple positions. Further, other layouts may include more or fewer radar units and can include radar units positioned differently overall.

As shown in FIG. 7A, radar unit 702 is positioned behind the back wheels of vehicle 700 near back bumper 706, but can have other locations in additional examples. Further, radar unit 702 is shown positioned approximately 7 inches above the ground and below the bumper line of back bumper 706 of vehicle 700. At 7 inches off the ground, radar unit 702 may have a FOV that enables measurements to be captured by radar unit 702 that encounter less interference from objects in the environment, including vehicles traveling nearby vehicle 700. Rather, radar may travel below nearby vehicles. In some instances, radar may scatter and reflect off the ground towards surfaces that are measured by radar unit 702.

Radar unit 704 is positioned behind the front wheels of vehicle 700 and is further shown coupled to the underbody such that it is approximately 6 inches above the ground. Similar to radar unit 702, the height and position of radar unit 704 may enable it to capture measurements with less interference from objects in the surrounding environment, including nearby vehicles. In other examples, radar unit 704 may have a position closer to front bumper 708.

FIG. 7B illustrates a bottom view of the vehicle for positioning radar units to the underbody of vehicle 700. The positions 710, 712, 714, 716 are shown to represent example locations that one or more radar units may be coupled to the underbody of vehicle 700. In other examples, radar units may be coupled at other positions on the underbody of the vehicle. Further, in examples involving other vehicles, the positions for coupling radar units to the underbody of a vehicle may depend on the configuration of components of the underbody.

Example position 710 is shown positioned nearby back bumper 706. For instance, radar units coupled in or nearby position 710 may measure areas under and behind vehicle 700. Example positions 712, 714 are shown positioned in a middle section of vehicle 700. In particular, radar units coupled in or nearby positions 712, 714 can have a position between the back wheels and front wheels of vehicle 700. Example position 716 is located near front bumper 708. For instance, radar units coupled in or near position 716 may measure areas under and in front of vehicle 700. These example positions are shown for illustration purposes, but can differ within examples.

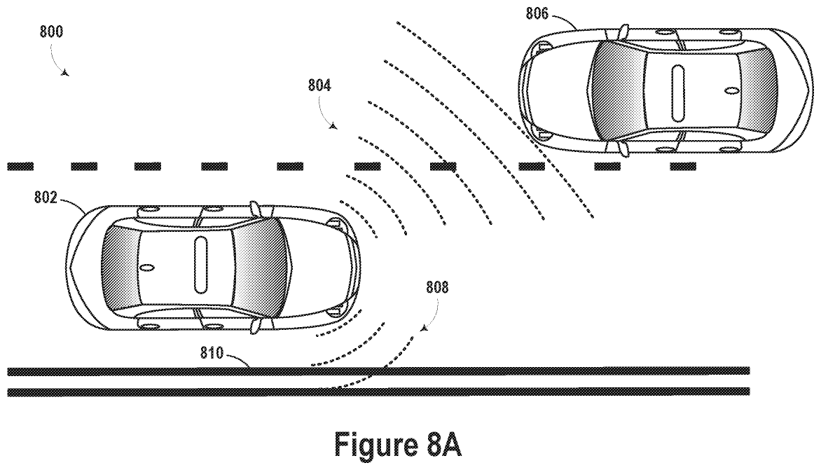

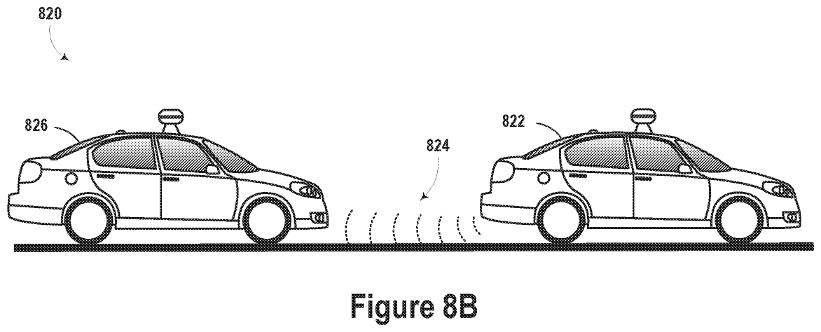

FIG. 8A illustrates scenario 800 involving a vehicle radar system detecting a nearby vehicle. Particularly, scenario 800 shows an aerial view of vehicle 802 using radar to measure nearby areas of the environment, including areas that include a portion of vehicle 806 and road curb 810. As such, scenario 800 represents one possible scenario involving a vehicle using radar to measure the environment, but other examples are possible.

Vehicle 802 represents a vehicle that may be configured with a radar system to measure the environment. The vehicle radar system may include one or multiple radar units coupled to the underbody of vehicle 802 with FOV(s) below a bumper line of vehicle 802.

Because radar is measuring a wide, forward environment of vehicle 802, the radar unit or radar units transmitting and receiving the radar signals may be below a bottom portion of the front bumper of vehicle 802. In a further example, one or multiple radar units may be coupled to a bottom of the front bumper or built into the front bumper to conduct the measurements. In addition, vehicle 806 may also be using a radar system to measure the nearby environment (not shown).

As shown in FIG. 8A, signals 804, 808 represent radar signals transmitted by one or more radar units coupled to vehicle 802. More specifically, signals 804, 808 may originate from one or more radar units coupled to the underbody of vehicle 802. In other examples, signals 804, 808 may represent radar reflection signals reflecting off vehicle 806 and road curb 808. These radar reflection signals may be received by the same or different radar units coupled to vehicle 802 (e.g., the radar unit(s) coupled to the underbody and transmitting signals 804, 808). Signals 804, 808 are shown for illustration purposes and may not be visible in real-world implementations. Further, additional signals may propagate from radar units in other directions away from vehicle 802.

FIG. 8B illustrates scenario 820 involving a vehicle radar system detecting a nearby vehicle. In particular, scenario 820 includes vehicle 822 using radar to measure the environment, including an area behind vehicle 822 that includes vehicle 826. Other scenarios involving use of vehicle radar systems are possible.

Similar to vehicle 802 depicted in FIG. 8A, vehicle 822 represents a vehicle that may use a vehicle radar system, which may include one or more radar units coupled to its underbody. The radar unit(s) coupled to the underbody may have a FOV that is not impacted by bumpers or other low portions of the frame of vehicle 822. In some examples, one or more radar units may be above a bumper line of vehicle 822, but may be coupled at a downward orientation that enables the unit(s) to receive measurements of an area nearby vehicle 826.

Signals 824 represent radar signals that may be transmitted by one or more antenna arrays of one or more radar units coupled to the underbody of vehicle 822. As such, processing the reflections of signals 824 off surfaces in the environment (e.g., vehicle 826) may produce measurements of the environment for a vehicle control system of vehicle 822 to use during navigation. For instance, the vehicle control system may use radar measurements to detect potential obstacles, monitor road elements (e.g., follow road boundaries), detect weather conditions, and perform other potential operations.

In some examples, the radar measurements obtained by the vehicle radar system may accurately depict the position, motion, and spatial orientation of features in the environment relative to vehicle 822.

In some examples, vehicle 822 may use signals 824 to assist during braking processes. For instance, vehicle 822 may use signals 824 to determine how far to stop from a vehicle traveling in front of vehicle 822 or to assist with timing of applying brakes (i.e., when to initiating a braking process). As an example, vehicle 822 may determine that vehicle 826 corresponds to a driver-operated vehicle based on detected movements or other information acquired regarding vehicle 822. As such, vehicle 822 may use radar (e.g., signals 824) to determine when to initiate braking and how far to stop from a vehicle in front of vehicle 826 in response to detecting that vehicle 826 is currently being operated by a driver. In turn, vehicle 822 may reduce risks associated with vehicle 826 potentially tailgating vehicle 822 (i.e., traveling too close to vehicle 822). In further examples, vehicle 822 may use near-field radar from radar units coupled to the underbody of vehicle 822 to maintain a buffer for safety and obstacle avoidance.

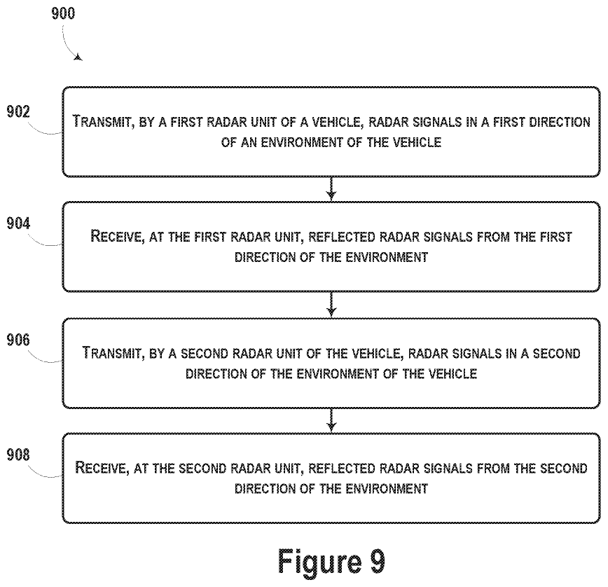

FIG. 9 is a flowchart of example method 900, which may include one or more operations, functions, or actions, as depicted by one or more of blocks 902, 904, 906, and 908, each of which may be carried out by any of the systems shown in prior figures, among other possible systems.

Those skilled in the art will understand that the flow chart described herein illustrate functionality and operation of certain implementations of the present disclosure. In this regard, each block of the flowchart may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art. In examples, a computing system may cause a radar system to perform one or more blocks of method 900.

Block 902 involves transmitting, by a first radar unit of a vehicle, radar signals in a first direction of an environment of the vehicle. Particularly, the first radar unit may be coupled to the underbody of the vehicle such that the first radar unit has a FOV below a bumper line of the vehicle. The bumper line of the vehicle may correspond to a bottom portion of a bumper of the vehicle or another portion of the vehicle located close to the ground under the vehicle.

In some examples, the first radar unit may be coupled to the underbody of the vehicle at a height off the ground that is below the bumper line of the vehicle. In other examples, the first radar unit may be coupled at a position that is not below the bumper line of the vehicle. As such, the first radar unit may be coupled at a downward orientation (e.g., four degrees from a horizontal plane) such that the first radar unit has the FOV below the bumper line of the vehicle.

In some examples, the first radar unit may be configured to transmit radar towards a particular area in the environment of the vehicle, such as the forward-looking environment of the vehicle. Alternatively, the first unit may be configured to measure areas 360 degrees around it, including areas under and around the vehicle.

Further, the vehicle radar system may also include one or more additional radar units configured to measure the first direction of the environment of the vehicle. For example, a vehicle may include a first forward-facing radar unit positioned proximate a first corner of the vehicle (e.g., by a first front wheel and the front bumper of the vehicle) and a second forward-facing radar unit positioned proximate a second corner of the vehicle (e.g., by a second front wheel and the front bumper of the vehicle). In other examples, the vehicle radar system may include more or fewer radar units positioned at other locations on the underbody or within a bumper or bumpers of the vehicle.

Block 904 involves receiving, at the first radar unit, reflected radar signals from the first direction of the environment. The first radar unit or another radar unit may receive the reflected radar signals for subsequent processing.

Block 906 involves transmitting, by a second radar unit of the vehicle, radar signals in a second direction of the environment of the vehicle. The second radar unit may be coupled to the underbody of the vehicle such that the second radar unit has a FOV below a bumper line of the vehicle.

In some examples, the second radar may be coupled to the underbody of the vehicle at a position (e.g., height off the ground) that is below the bumper line of the vehicle. In other examples, the second radar unit may be coupled at a position that is not below the bumper line of the vehicle. As such, the second radar unit may be coupled at a downward orientation (e.g., four degrees from a horizontal plane) such that the second radar unit has the FOV below the bumper line of the vehicle.

In some examples, the second radar unit may be configured to transmit radar towards a particular area in the environment of the vehicle, such as the rear-looking environment of the vehicle. Alternatively, the second unit may be configured to measure areas 360 degrees around it, including areas under and around the vehicle.

Further, the vehicle radar system may also include one or more additional radar units configured to measure the environment of the vehicle in the second direction. For example, a vehicle may include a first rear-facing radar unit positioned proximate a first corner of the vehicle (e.g., by a first rear wheel and the rear bumper of the vehicle) and a second rear-facing radar unit positioned proximate a second corner of the vehicle (e.g., by a second rear wheel and the rear bumper of the vehicle). In other examples, the vehicle radar system may include more or fewer radar units positioned at other locations on the underbody or within a bumper or bumpers of the vehicle.

Block 908 involves receiving, at the second radar unit, reflected radar signals from the second direction of the environment. The second radar unit or another radar unit may receive the reflected radar signals for subsequent processing.

In further examples, the vehicle radar system used to perform method 900 or similar methods may further involve radar units coupled at other positions of the underbody of the vehicle, such as one of the example configurations shown in FIGS. 5A-5C, FIGS. 6A-6D, or FIGS. 7A-7B. For example, a vehicle radar system may performing method 900 may further include one or more radar units coupled to a middle portion of the underbody of the vehicle (i.e., between front wheels of the vehicle and back wheels of the vehicle). The one or more radar units coupled to the middle portion of the underbody may be configured to measure areas 360 degrees around including areas under and around the vehicle.

In some examples, the vehicle radar system used to perform method 900 or similar methods can include radar units coupled at other positions of the vehicle. For instance, the vehicle radar system may include a sensor dome mounted to a top of the vehicle. The sensor dome may house one or more radar units, such as radar units configured to operate at a long range. As such, the vehicle radar system may use a combination of measurements for the various radar units to measure the environment of the vehicle.

The vehicle radar system performing method 900 or similar methods may further include one or more processors configured to perform operations using radar measurements from the radar units coupled to the vehicle's underbody. The one or more processors may be part of the vehicle radar system or another computing system associated with the vehicle (e.g., a vehicle control system). In some examples, the one or more processors may operate partially on board the vehicle and partially at a remote location from the vehicle. In further examples, the one or more processors may correspond to a remote computing system configured to assist with navigation and control of operations of the vehicle.

In some examples, a processor may receive radar measurements from one or both of the first side-facing radar unit and the second side-facing radar unit (or other radar units of the vehicle radar system) and use the radar measurements to detect a passenger or passengers entering or exiting the vehicle. For example, radar from one or more underbody radar units can detect a passenger approaching the vehicle and also further detect when the passenger is positioned inside the vehicle. As such, responsive to detecting the passenger entering or exiting the vehicle, the processor may cause the vehicle to remain stationary (e.g., transmit a signal to the vehicle control system to refrain from initiating navigation). The processor may further receive subsequent radar measurements from one or both of the first side-facing radar unit and the second side-facing radar unit and determine, using the subsequent radar measurements, that the passenger entering or exiting the vehicle is either positioned inside the vehicle or at least a threshold distance away from the vehicle. Based on the determination, the processor may cause the vehicle to resume navigation (e.g., transmit a signal to the vehicle control system to resume navigation).

In some examples, a processor may receive radar measurements from at least the forward-facing radar unit or the rear-facing radar unit (or another underbody radar unit). As such, the processor may determine weather conditions of a path of travel of the vehicle based on the radar measurements. In addition, the processor may also determine road conditions of the path of travel of the vehicle based on the radar measurements. For example, the processor can determine the wetness of a road, material type (e.g., gravel, asphalt), or other conditions that can impact navigation. In other examples, the processor may use radar measurements from one or more underbody radar units to determine information about nearby vehicles, such as the speed and orientation of a vehicle traveling nearby.

In some examples, a processor may receive radar measurements from one or more underbody radar units to determine heights of objects (e.g., bumps, physical objects, etc.) on a path of travel and/or depths of channels or holes in the path of travel. The processor may use measurements to gain a more in-depth understanding of the environment of the vehicle.

In further examples, method 900 or similar methods may involve causing a portion of the vehicle to adjust position to obtain measurements of the environment using underbody radar. For instance, method 900 may further involve causing a front end of the vehicle to tilt at an upward orientation and responsive to causing the front end of the vehicle to tilt at the upward orientation, transmitting and receiving radar signals (and reflected radar signals) in the forward-looking environment by the forward-facing radar unit. The vehicle may similarly cause a back end of the vehicle to tilt upward to capture measurements behind the vehicle.

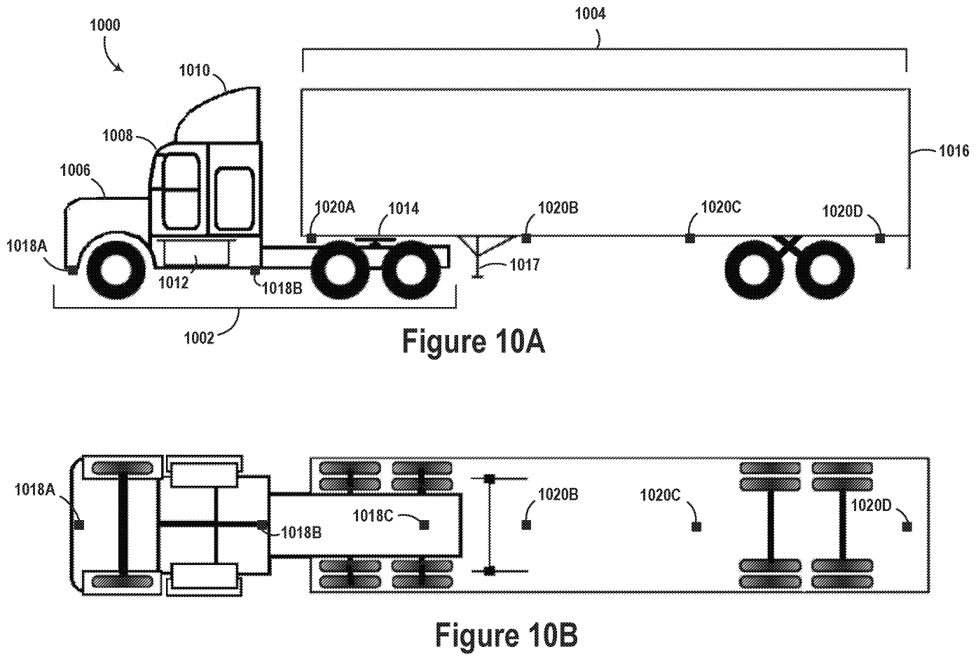

FIGS. 10A and 10B illustrate an example configuration for coupling radar units to the underbody of a vehicle. In particular, vehicle 1000 is a semi-trailer truck that includes radar units coupled at various positions to the underbodies of the tractor unit 1002 and semi-trailer 1004.

Vehicle 1000 represents a larger vehicle that may use underbody radar to assist with several operations, and such as navigation, semi-trailer detection and monitoring, among others. As such, the configuration of vehicle 1000 as well as the layout of radar units coupled to vehicle 1000 serves as one example implementations. Other examples can involve other types of vehicles (e.g., multi-trailer trucks, military vehicles, off road vehicles). In addition, other example layouts can be used for coupling radar units to the underbody of vehicle 1000 or other vehicles, which may include more or fewer radar units in other configurations.

FIG. 10A illustrates a side view of vehicle 1000 with radar units 1018A, 1018B, 1020A, 1020B, 1020C, and 1020D coupled to the underbody of the vehicle (i.e., radar units 1018A, 1018B coupled to tractor unit 1002 and radar units 1020A, 1020B, 1020C, and 1020D coupled to semi-trailer 1004).

As shown in FIG. 10A, tractor unit 1002 includes engine compartment 1006, cabin 1008, air dam 1010, fuel tank 1012, and fifth wheeling coupling 1014. Tractor unit 1002 may be configured navigate and transport items within semi-trailer 10004. As such, tractor unit 1002 represents one example configuration of a vehicle configured to transport objects within semi-trailer 1004. Other examples of tractor unit 1002 are possible.

Engine compartment 1006 represents an area where an engine may be housed. As such, the engine may correspond to a complex mechanical device configured to convert energy into useful motion for tractor unit 1002. In some examples, tractor unit 1002 may include one or multiple engines. In other instances, tractor unit 1002 may an electric vehicle powered by one or multiple electric motors.

Cabin 1008 is shown as an enclosed space where a driver and/or passengers may be seated. In other examples, the size and configuration of cabin 1008 can differ. As such, cabin 1008 may also include a sleeper where a driver or passenger may rest. Air dam 1010 represents an aerodynamic device configuration to enhance operation of tractor unit 1002.

Semi-trailer 1004 is shown coupled to tractor unit 1002 and includes enclosed cargo space 1016 and landing gear 1017 configured for use when semi-trailer 1004 is detached from tractor unit 1002. As such, semi-trailer 1004 and tractor unit 1002 may include components configured to couple them together. Cargo space 1016 may hold and protect objects or materials during transportation by tractor unit 1002.

Radar units 1018A, 1018B are shown coupled to the underbody of tractor unit 1002. The positions and orientations of radar units 1018A, 1018B represent one example layout of coupling radar units to 1018A, 1018B to tractor unit 1002. In other examples, tractor unit 1002 can include more or fewer radar units at other positions. For example, tractor unit 1002 may only include radar unit 1018B coupled to its underbody. Further, although radar units 1018A, 1018B are shown below a bumper line of tractor unit 1002, radar units 1018A, 1018B can be positioned at different heights off the ground in other examples.

In addition, radar units 1020A, 1020B, 1020C, and 1020D are shown coupled to the underside (i.e., underbody) of semi-trailer 1004. The positions and orientations of radar units 1020A, 1020B, 1020C, and 1020D represent one example layout of coupling radar units to semi-trailer 1004. In other examples, semi-trailer 1004 can include more or fewer radar units at other positions. Further, although radar units 1020A, 1020B, 1020C, and 1020D are shown below a bumper line of semi-trailer 1004, radar units 1020A, 1020B, 1020C, and 1020D can be positioned at different heights off the ground in other examples.

FIG. 10B illustrates a bottom view of the vehicle with radar units coupled to the underbody of the vehicle. Radar units 1018A, 1018B, 1018C are shown positioned to the underbody of tractor unit 1002 and radar units 1020A (not shown), 1020B, 1020C, and 1020D are coupled to the underbody of semi-trailer 1004. In other examples, only tractor unit 1002 or semi-trailer 1004 may include radar units positioned on its underbody.

A radar system associated with tractor unit 1002 and semi-trailer 1004 may receive measurements from all (or a subset) of radar units 1018A, 1018B, 1020A, 1020B, 1020C, and 1020D. The radar system may use measurements from the various radar units to perform various operations.

In some examples, vehicle 1000 may use radar measurements from one or more radar units coupled to the underbody of tractor unit 1002 and/or semi-trailer 1004 to determine a weight of the load in enclosed cargo space. For instance, underbody radar can help detect changes in the height of semi-trailer 1004 after cargo space 1016 is loaded up with items for transportation.

In addition, radar measurements from the various radar units placed on the underbody of tractor unit 1002 and/or semi-trailer 1004 can be used to estimate the angle location of semi-trailer 1004 relative to tractor unit 1002. Underbody radar can assist with determining the pose of vehicle 1000 during operation as well as the individual pose of tractor unit 1002 and semi-trailer 1004 relative to each other. Underbody radar can also help detect differences in pose between tractor unit 10002 and semi-trailer 1004, which may include variation (e.g., different degrees of freedom) caused by the suspensions of each tractor unit 1002 and semi-trailer 1004.

In some examples, radar measurements can be used to help automate attachment and removal of semi-trailer 1004. For instance, radar measurements from one or more radar units coupled to the underbody of semi-trailer 1004 (e.g., radar unit 1020A, 1020B) can detect the location of coupling components of tractor unit 1002. Radar measurements from underbody radar can assist with aligning semi-trailer 1004 with tractor unit 1002, connecting, and removal of semi-trailer 1004 from tractor unit 1002. In further examples, radar unit 1020D or another underbody radar unit can be configured to detect and assist with navigating tractor unit 1002 to dock to an unloading or loading station.

In another embodiment, underbody radar can be used to help detect and identify a blowout condition of a wheel on tractor unit 1002 or semi-trailer 1004. Vehicle 1000 can include numerous wheels to enable transportation of goods. As such, radar can assist with detecting when a wheel of vehicle 1000 is impaired (e.g., flat, blowout). Other configuration of vehicles (e.g., vehicle 200) may also use underbody radar to detect and identify wheel issues.

In further examples, underbody radar can also assist with detecting and preventing theft. For instance, radar unit 1020D or other underbody radar units can measure an area around an opening of semi-trailer 1004 to detect when someone enters into the area. As a result, a vehicle security system may use radar measurements to provide an alert when an unpermitted person is positioned nearby semi-trailer 1004. Similarly, underbody radar may be used to detect non-authorized riders that may attempt to ride in semi-trailer 1004. Vehicle 1000 and other vehicles may use underbody radar units for surveillance of the vehicle in general.

In further examples, vehicle 1000 may include multiple semi-trailers with one linked to the tractor-trailer and others (e.g., a second semi-trailer) linked behind the first one. As such, radar units positioned on the undersides of one or more semi-trailers can be used to determine information related to operation of vehicle 1000. For instance, radar units coupled underneath the first semi-trailer may detect whether it is connected to the tractor-trailer and whether a second semi-trailer is connected to the first semi-trailer. Further, radar units coupled to the underbody of the semi-trailers or the tractor-trailer may be used to determine a pose of the one or more semi-trailers relative to the tractor-trailer or other information related to operating the multiple semi-trailers.

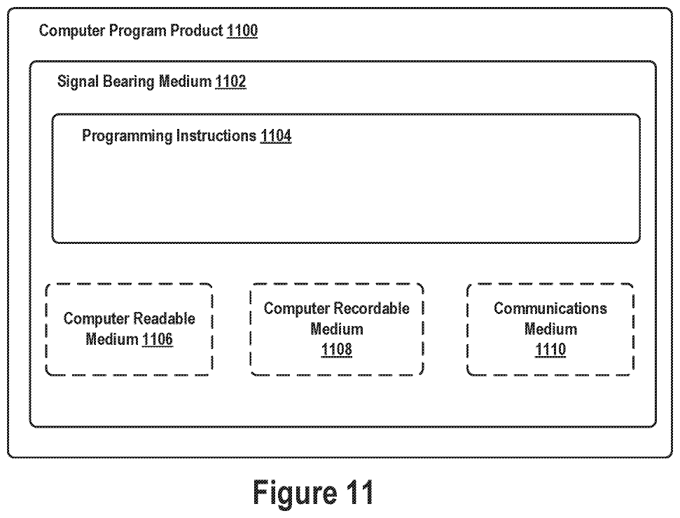

FIG. 11 is a schematic illustrating a conceptual partial view of an example computer program product that includes a computer program for executing a computer process on a computing device, arranged according to at least some embodiments presented herein. In some embodiments, the disclosed methods may be implemented as computer program instructions encoded on a non-transitory computer-readable storage media in a machine-readable format, or on other non-transitory media or articles of manufacture.

Example computer program product 1100 may be provided using signal bearing medium 1102, which may include one or more programming instructions 1104 that, when executed by one or more processors may provide functionality or portions of the functionality described above with respect to FIGS. 1-13B. In some examples, the signal bearing medium 1102 may encompass a non-transitory computer-readable medium 1106, such as, but not limited to, a hard disk drive, a Compact Disc (CD), a Digital Video Disk (DVD), a digital tape, memory, etc. In some implementations, the signal bearing medium 1102 may encompass a computer recordable medium 1108, such as, but not limited to, memory, read/write (R/W) CDs, R/W DVDs, etc. In some implementations, the signal bearing medium 1002 may encompass a communications medium 1110, such as, but not limited to, a digital and/or an analog communication medium (e.g., a fiber optic cable, a waveguide, a wired communications link, a wireless communication link, etc.). Thus, for example, the signal bearing medium 1102 may be conveyed by a wireless form of the communications medium 1110.

The one or more programming instructions 1104 may be, for example, computer executable and/or logic implemented instructions. In some examples, a computing device such as the computer system 112 of FIG. 1 may be configured to provide various operations, functions, or actions in response to the programming instructions 1104 conveyed to the computer system 112 by one or more of the computer readable medium 1106, the computer recordable medium 1108, and/or the communications medium 1110.

The non-transitory computer readable medium could also be distributed among multiple data storage elements, which could be remotely located from each other. The computing device that executes some or all of the stored instructions could be a vehicle, such as vehicle 200 illustrated in FIG. 2, among other possibilities. Alternatively, the computing device that executes some or all of the stored instructions could be another computing device, such as a server.

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

It should be understood that arrangements described herein are for purposes of example only. As such, those skilled in the art will appreciate that other arrangements and other elements (e.g. machines, apparatuses, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

What is claimed is:

1. A radar system comprising:
a set of radar units coupled to an underbody of a vehicle such that each radar unit has a field of view below a bumper line of the vehicle, wherein the set of radar units includes:
a first radar unit configured to measure an environment of the vehicle in a first direction; and
a second radar unit configured to measure the environment of the vehicle in a second direction, wherein the second direction differs from the first direction.

2. The radar system of claim 1, wherein the first radar unit configured to measure the environment of the vehicle in the first direction comprises:
a forward-facing radar unit configured to measure at least a forward-looking environment of the vehicle, wherein the forward-facing radar unit is positioned proximate a front bumper of the vehicle.

3. The radar system of claim 2, wherein the second radar unit configured to measure the environment of the vehicle in the second direction comprises:
a rear-facing radar unit configured to measure a rear-looking environment of the vehicle, wherein the rear-facing radar unit is positioned proximate a back bumper of the vehicle

4. The radar system of claim 1, wherein the set of radar units further comprises:
a given radar unit coupled to a middle portion of the underbody of the vehicle, wherein the middle portion of the underbody is between front wheels of the vehicle and back wheels of the vehicle.

5. The radar system of claim 4, wherein the given radar unit coupled to the middle portion of the underbody of the vehicle is configured to measure areas 360 degrees around the given radar unit, wherein the areas include respective areas under and around the vehicle.

6. The radar system of claim 1, further comprising a processor, wherein the processor is configured to:
receive radar measurements from one or both of the first radar unit and the second radar unit; and
detect, using the radar measurements, a passenger entering or exiting the vehicle.

7. The radar system of claim 6, wherein the processor is further configured to:
responsive to detecting the passenger entering or exiting the vehicle, cause the vehicle to remain stationary;
receive subsequent radar measurements from one or both of the first radar unit and the second radar unit;
determine, using sensor measurements, that the passenger entering or exiting the vehicle is either positioned inside the vehicle or at least a threshold distance away from the vehicle; and
based on the determination, permit the vehicle to resume navigation.

8. The radar system of claim 1, wherein the set of radar units further comprises:
a third radar unit configured to measure the environment of the vehicle in the first direction, wherein the first radar unit is positioned proximate a first front corner of the vehicle, and wherein the third radar unit is positioned proximate a second front corner of the vehicle.

9. The radar system of claim 1, further comprising:
a fourth radar unit configured to measure the second environment of the vehicle, wherein the second radar unit is positioned proximate a first back corner of the vehicle, and wherein the fourth radar unit is positioned proximate a second back corner of the vehicle.

10. The radar system of claim 1, wherein the set of radar units are configured to operate at short or medium ranges, and
wherein the radar system further comprises a sensor dome mounted to a top of the vehicle, wherein the sensor dome houses one or more radar units configured to operate at a long range.

11. The radar system of claim 1, wherein the bumper line of the vehicle corresponds to a bottom portion of a bumper of the vehicle.

12. The radar system of claim 11, wherein the first radar unit is coupled to the underbody of the vehicle at a downward orientation such that the first radar unit has the field of view below the bumper line of the vehicle.

13. The radar system of claim 11, wherein the second radar unit is coupled to the underbody of the vehicle at a downward orientation such that the second radar unit has the field of view below the bumper line of the vehicle.

14. The radar system of claim 1, further comprising a processor, wherein the processor is configured to:
receive radar measurements from at least the first radar unit or the second radar unit; and
determine road conditions of a path of travel of the vehicle based on the radar measurements.

15. The radar system of claim 1, further comprising a processor, wherein the processor is configured to:
receive radar measurements from at least the first radar unit or the second radar unit; and
determine road surface conditions of a path of travel of the vehicle based on the radar measurements.

16. The radar system of claim 1, further comprising a processor, wherein the processor is configured to:
receive radar measurements from at least the first radar unit or the second radar unit; and
determine a speed and an orientation of a given vehicle traveling nearby the vehicle based on the radar measurements.

17. A method of operating a radar system:
transmitting, by a first radar unit of a vehicle, radar signals in a first direction of an environment of the vehicle;
receiving, at the first radar unit, reflected radar signals from the first direction of the environment;
transmitting, by a second radar unit of the vehicle, radar signals in a second direction of the environment of the vehicle, wherein the second direction differs from the first direction; and
receiving, at the second radar unit, reflected radar signals from the second direction of the environment, wherein the first radar unit and the second radar unit are coupled to an underbody of the vehicle such that each radar unit has a field of view below a bumper line of the vehicle.

18. The method of claim 17, further comprising:
responsive to a portion of the vehicle changing elevation, transmitting, by the first radar unit, radar signals towards a particular environment of the vehicle; and
receiving, at the first radar unit, reflected radar signals from the particular environment.

19. A radar system comprising:
a processor configured to process radar measurements; and
a set of radar units configurable to couple to an underbody of a vehicle such that each radar unit has a field of view below a bumper line of the vehicle, wherein the set of radar units includes:
a first radar unit configured to measure an environment of the vehicle in a first direction; and
a second radar unit configured to measure the environment of the vehicle in a second direction, wherein the second direction differs from the first direction.

20. The radar system, wherein the processor is configured to:
receive radar measurements from one or both of the first radar unit and the second radar unit; and
based on the radar measurements, determine respective heights of road conditions of a path of travel of the vehicle.
